(19) United States
(12) Patent Application Publication
(10) Pub. No.: US 2015/0091824 A1
(43) Pub. Date: Apr. 2, 2015

(54) INFORMATION PROCESSING APPARATUS, INFORMATION PROCESSING METHOD, AND COMPUTER PROGRAM

(71) Applicant: SONY CORPORATION, Tokyo (JP)

(72) Inventor: Takuro Hori, Tokyo (JP)

(21) Appl. No.: 14/389,825

(22) PCT Filed: Jul. 19, 2013
(86) PCT No.: PCT/JP2013/004419

§ 371 Date: Oct. 1, 2014

(30) Foreign Application Priority Data
Aug. 7, 2012 (JP) 2012-174796

(51) Int. Cl. G06F 3/041; G06F 3/0346

(52) U.S. Cl. CPC G06F 3/041; G06F 3/0346
USPC 345/173

(57) ABSTRACT

An information processing system that identifies a posture of the information processing system, and determines whether a user input is received at the operation surface based on the identified posture of the information processing system.

### TECHNICAL FIELD

The present disclosure relates to an information processing apparatus, an information processing method, and a computer program.

The present disclosure contains subject matter related to that disclosed in Japanese Priority Patent Application JP 2012-174796 filed in the Japan Patent Office on Aug. 7, 2012, the entire content of which is hereby incorporated by reference.

### BACKGROUND ART

Devices having a touch panel, such as a smartphone, a tablet terminal, a digital camera and the like, are becoming more widely spread. When performing an input operation on the touch panel in such a device, the operator can operate the device by touching a screen provided on the touch panel with his/her fingers or by moving his/her fingers while still touching the screen.

There is a need to improve the operability of a device having such a touch panel. Technology directed to improving the operability of a device having a touch panel has been disclosed (refer to PTL 1 and 2 etc.).

### CITATION LIST

### Patent Literature

PTL 1: JP 2012-27875A

PTL 2: JP 2011-39943A

### SUMMARY

### Technical Problem

In a device having such a touch panel, a touch release from the touch panel that is not intended by the operator may be detected even when the operator is maintaining his/her touch on the touch panel or the operator's finger was moved while still touching. The above PTL 1 and PTL 2 disclose that operability can be improved by linking the amount of change in the tilt or movement of the device detected by a sensor for detecting device movement with the operations of the operator. However, PTL 1 and PTL 2 do not disclose anything about facilitating the operations intended by the operator or preventing mistaken operations that occur based on a touch release that was not intended by the operator.

Accordingly, by combining detection of changes in the orientation of the device, a novel and improved information processing apparatus, information processing method, and computer program can be provided that can improve operability when the operator operates the touch panel.

### Solution to Problem

According to an embodiment of the present disclosure, there is provided an information processing system that identifies a posture of the information processing system, and determines whether a user input is received at the operation surface based on the identified posture of the information processing system.

According to an embodiment of the present disclosure, there is provided an information processing method including identifying a posture of the information processing system, and determining whether a user input is received at the operation surface based on the identified posture of the information processing system.

According to an embodiment of the present disclosure, there is provided a computer program for causing a computer to identify a posture of the information processing system, and determine whether a user input is received at an operation surface based on the identified posture of the information processing system.

### Advantageous Effects of Invention

Thus, according to an embodiment of the present disclosure, by combining detection of changes in the orientation of the device, a novel and improved information processing apparatus, information processing method, and computer program can be provided that can improve operability when the operator operates the touch panel.

### BRIEF DESCRIPTION OF DRAWINGS

FIG. 1 is an explanatory diagram illustrating an appearance example of an imaging apparatus 100 according to an embodiment of the present disclosure as a perspective view from a rear face side of the imaging apparatus 100.

FIG. 2 is an explanatory diagram illustrating a function configuration example of the imaging apparatus 100 according to an embodiment of the present disclosure.

FIG. 3 is an explanatory diagram illustrating a function configuration example of a control unit 110 included in the imaging apparatus 100 according to an embodiment of the present disclosure.

FIG. 4A is an explanatory diagram illustrating an orientation change example of a housing 101 of the imaging apparatus 100.

FIG. 4B is an explanatory diagram illustrating an orientation change example of a housing 101 of the imaging apparatus 100.

FIG. 5 is an explanatory diagram illustrating how a threshold relating to an operation amount of an operation member changes.

FIG. 6 is an explanatory diagram illustrating a function configuration example of the control unit 110 included in the imaging apparatus 100 according to an embodiment of the present disclosure.

FIG. 7 is a flow diagram illustrating an operation example of the imaging apparatus 100 according to an embodiment of the present disclosure.

FIG. 8 is an explanatory diagram illustrating an example of a drag operation.

FIG. 9 is a flow diagram illustrating an operation example of the imaging apparatus 100 according to an embodiment of the present disclosure.

FIG. 10 is an explanatory diagram illustrating an example of a flick operation.

FIG. 11 is a flow diagram illustrating an operation example of the imaging apparatus 100 according to an embodiment of the present disclosure.

FIG. 12 is a flow diagram illustrating an operation example of the imaging apparatus 100 according to an embodiment of the present disclosure.

FIG. 13 is an explanatory diagram illustrating an example of a GUI that changes a display position of an icon based on approach detection.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be described in the following order.

<1. Embodiment of the present disclosure>

(Imaging apparatus appearance example)

(Imaging apparatus function configuration example)

(Control unit function configuration example (1))

(Outline of threshold change)

(Control unit function configuration example (2))

(Imaging apparatus operation examples)<

2. Conclusion>

### 1. EMBODIMENT OF THE PRESENT DISCLOSURE

### Imaging Apparatus Appearance Example

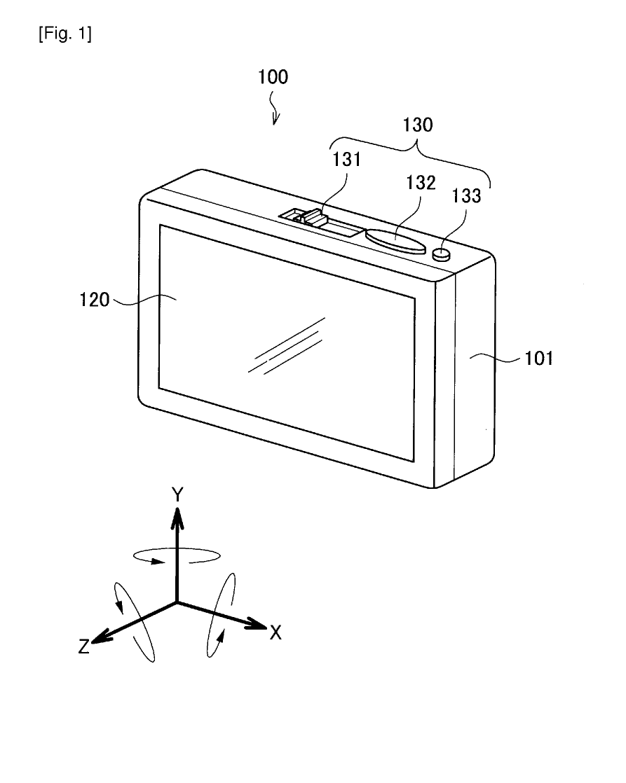

First, as an example of the information processing apparatus according to an embodiment of the present disclosure, an appearance example of the imaging apparatus according to an embodiment of the present disclosure will be described with reference to the drawings. FIG. 1 is an explanatory diagram illustrating an appearance example of an imaging apparatus 100 according to an embodiment of the present disclosure as a perspective view from a rear face side of an imaging apparatus 100. An appearance example of the imaging apparatus 100 according to the embodiment of the present disclosure will now be described with reference to FIG. 1.

As illustrated in FIG. 1, the imaging apparatus 100 according to an embodiment of the present disclosure includes a display unit 120 and an operation unit 130 in a housing 101.

The display unit 120 displays images captured by the imaging apparatus 100, and displays various setting screens of the imaging apparatus 100. A (below described) touch panel is provided on the display unit 120. The user of the imaging apparatus 100 can operate the imaging apparatus 100 by touching the touch panel provided on the display unit 120 with an operation member, such as his/her finger.

The operation unit 130, which lets the user operate the imaging apparatus 100, is configured from buttons and switches for operating the imaging apparatus 100. As the operation unit 130, a zoom button 131, a shutter button 132, and a power button 133 are illustrated in FIG. 1. The zoom button 131 is for changing the magnification during imaging with the imaging apparatus 100. The shutter button 132 is for capturing images with the imaging apparatus 100. The power button 133 is for turning the power of the imaging apparatus 100 ON/OFF.

Needless to say, the appearance of the imaging apparatus 100 is not limited to this example. Further, needless to say, the buttons and switches configuring the operation unit 130 are not limited to those illustrated in FIG. 1.

The imaging apparatus 100 according to an embodiment of the present disclosure changes a threshold relating to an operation amount of an operation member, such as a user's finger, for recognizing an operation as a user operation based on a change in the orientation of the housing 101 by detecting changes in orientation of the housing 101 of the imaging apparatus 100 when an operation is performed on the touch panel provided on the display unit 120. By thus changing a threshold relating to the operation amount of the operation member, the imaging apparatus 100 according to an embodiment of the present disclosure can improve operability when the user performs an operation on the touch panel.

In the following description, the X-axis, Y-axis, and Z-axis are defined as illustrated in FIG. 1. Namely, the X-axis is the axis along the long side of the display unit 120, the Y-axis is the axis along the short side of the display unit 120, and the Z-axis is the axis orthogonal to the X-axis and the Y-axis.

An appearance example of the imaging apparatus 100 according to an embodiment of the present disclosure was described above with reference to FIG. 1. Next, a function configuration example of the imaging apparatus 100 according to an embodiment of the present disclosure will be described.

(Imaging Apparatus Function Configuration Example)

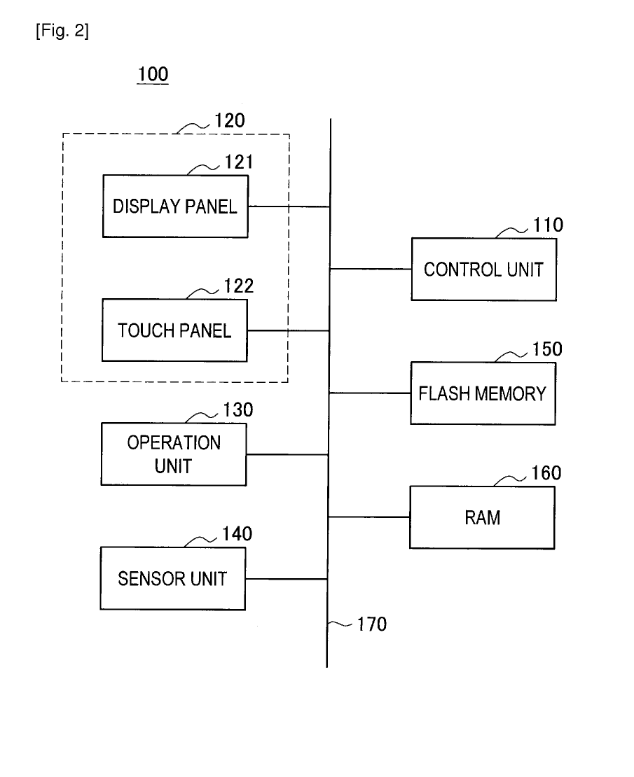

FIG. 2 is an explanatory diagram illustrating a function configuration example of the imaging apparatus 100 according to an embodiment of the present disclosure. A function configuration example of the imaging apparatus 100 according to an embodiment of the present disclosure will now be described with reference to FIG. 2.

As illustrated in FIG. 2, the imaging apparatus 100 according to an embodiment of the present disclosure includes the control unit 110, the display unit 120, the display unit 120, a flash memory 150, and a RAM 160.

The control unit 110 controls the operation of the imaging apparatus 100. In the present embodiment, the control unit 110 executes control to change a threshold relating to an operation amount of the operation member, such as the user's finger, for recognizing an operation as a user operation based on a change in the orientation of the housing 101. The control unit 110 can also control the operation of the imaging apparatus 100 by, for example, reading computer programs recorded in the flash memory 150, and sequentially executing the computer programs. A specific configuration example of the control unit 110 will be described in more detail below.

As described above, the display unit 120 displays images captured by the imaging apparatus 100, and displays various setting screens of the imaging apparatus 100. As illustrated in FIG. 2, the display unit 120 includes a display panel 121 and a touch panel 122. The display panel 121 displays images captured by the imaging apparatus 100, and displays various setting screens of the imaging apparatus 100. The display panel 121 is configured from a flat display panel, such as a liquid crystal display panel or an organic EL display panel, for example. The touch panel 122 is provided on the display panel 121. The user can operate the imaging apparatus 100 by touching the touch panel 122 with an operation member, such as his/her finger. Therefore, the control unit 110 executes various processes based on the touch state of the operation member on the touch panel 122.

The operation unit 130, which lets the user operate the imaging apparatus 100, is configured from buttons and switches for operating the imaging apparatus 100. The control unit 110 executes various processes based on the operation state of the operation unit 130. Examples of the various processes that are executed by the control unit 110 based on the operation state of the operation unit 130 include processing for turning the power of the imaging apparatus 100 ON/OFF, processing for changing magnification during imaging as well as other imaging conditions, processing for capturing still images and moving images and the like.

A sensor unit 140 detects a tilt of the housing 101 of the imaging apparatus 100. For the sensor unit 140, an angular velocity sensor or an acceleration sensor may be used, for example. The sensor unit 140 detects a rotation angle of the imaging apparatus 100 in any of a first axis, a second axis, or a third axis. It is noted that it is sufficient for the sensor unit 140 to detect rotation of the imaging apparatus 100 in at least one or more axes.

The flash memory 150 is a non-volatile memory in which the various computer programs that are used for the processing performed by the control unit 110 and various data are stored. Further, the RAM 160 is a working memory that is used during processing by the control unit 110.

It is noted that the control unit 110, the display unit 120, the operation unit 130, the sensor unit 140, the flash memory 150, and the RAM 160 are connected to each other via a bus 170, and can communicate with each other.

A function configuration example of the imaging apparatus 100 according to an embodiment of the present disclosure was described above with reference to FIG. 2. Next, a function configuration example of the control unit 110 included in the imaging apparatus 100 according to an embodiment of the present disclosure will be described.

(Control Unit Function Configuration Example (1))

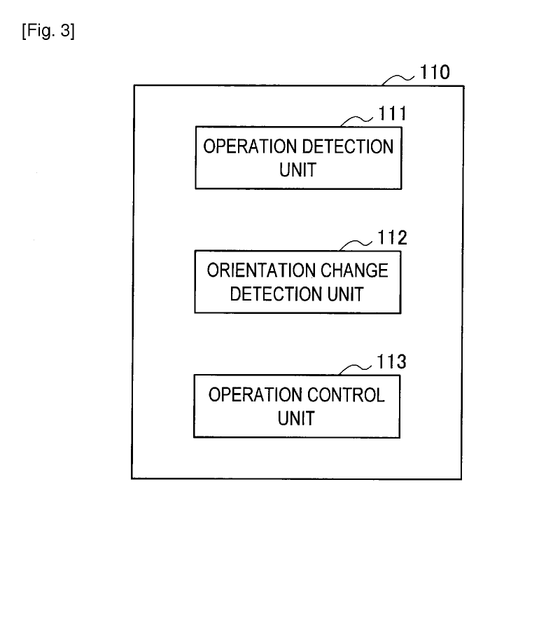

FIG. 3 is an explanatory diagram illustrating a function configuration example of the control unit 110 included in the imaging apparatus 100 according to an embodiment of the present disclosure. A function configuration example of the control unit 110 included in the imaging apparatus 100 according to an embodiment of the present disclosure will be described with reference to FIG. 3.

As illustrated in FIG. 3, the control unit 110 included in the imaging apparatus 100 according to an embodiment of the present disclosure includes an operation detection unit 111, an orientation change detection unit 112, and an operation control unit 113.

The operation detection unit 111 detects for the presence of a user operation on the touch panel 122 or the operation unit 130. If the operation detection unit 111 detects the presence of a user operation on the touch panel 122 or the operation unit 130, processing based on that user operation is executed by the operation control unit 113.

An example will be described in which the operation member, such as the user's finger, touched the touch panel 122. When the operation member, such as the user's finger, approaches or touches the touch panel 122, the touch panel 122 notifies the operation detection unit 111 of the approach detection coordinates, the approach release coordinates, the touch detection coordinates, the touch release coordinates, approach coordinate movement, and touch coordinate movement. If the touch panel 122 is a pressure-sensitive touch panel capable of detecting a pressing force, the touch panel 122 also notifies the operation detection unit 111 of the pressing force of the operation member. Based on the coordinates received from the touch panel 122, the operation detection unit 111 determines whether the operation is an approach, approach release, touch, touch release, drag, flick, long press, or depress touch, and notifies the operation control unit 113. The operation control unit 113 executes processing based on the information notified from the operation detection unit 111.

A drag operation refers to an operation in which, after touch of the touch panel 122 has been detected, the touch coordinate is moved a predetermined amount or more while touch is maintained. A flick operation refers to an operation in which, after touch of the touch panel 122 has been detected, the touch coordinate is moved while touch is maintained, and then touch of the touch panel 122 is released. A long press operation (hold operation) refers to an operation in which, after touch of the touch panel 122 has been detected, the touch is maintained for a predetermined amount of time or more.

The orientation change detection unit 112 detects changes in orientation of the housing 101 of the imaging apparatus 100. The orientation change detection unit 112 detects changes in orientation of the housing 101 of the imaging apparatus 100 using information regarding the tilt of the housing 101 of the imaging apparatus 100 acquired from the sensor unit 140. For example, if an acceleration sensor is used for the sensor unit 140, the orientation change detection unit 112 acquires a tilt angle of the housing 101 of the imaging apparatus 100 from the acceleration sensor, and stores the acquired tilt angle in the RAM 160. Further, for example, if an angular velocity sensor is used for the sensor unit 140, the orientation change detection unit 112 calculates a rotation angle of the housing 101 of the imaging apparatus 100 by integrating angular velocities acquired from the rotation angular velocity sensor, and stores the calculated rotation angle in the RAM 160.

In the present embodiment, the orientation change detection unit 112 detects that the orientation of the 101 of the imaging apparatus 100 has changed based on information obtained from the sensor unit 140. When the orientation change detection unit 112 detects that the orientation of the 101 of the imaging apparatus 100 has changed, control based on that orientation change is executed by the operation control unit 113.

The operation control unit 113 controls operation of the imaging apparatus 100. The operation control unit 113 controls operation of the imaging apparatus 100 based on a user operation on the touch panel 122 or the operation unit 130 that is detected by the operation detection unit 111.

In the present embodiment, the operation control unit 113 executes control to change a threshold relating to the operation amount of the operation member, such as the user's finger, for recognizing an operation as a user operation based on a change in the orientation of the housing 101 of the imaging apparatus 100 detected by the orientation change detection unit 112. The threshold relating to the operation amount of the operation member is, for example, a threshold for executing an operation that has been continued for a predetermined distance or predetermined duration, such as the drag operation, flick operation, long press operation (hold operation) and the like. By executing control to change the threshold relating to the operation amount of the operation member with the operation control unit 113, the imaging apparatus 100 according to an embodiment of the present disclosure can improve operability when the user performs an operation on the touch panel.

A function configuration example of the control unit 110 included in the imaging apparatus 100 according to an embodiment of the present disclosure was described above with reference to FIG. 3. Next, an outline of changes to the threshold relating to the operation amount of the operation member performed by the imaging apparatus 100 according to an embodiment of the present disclosure will be described.

(Outline of Threshold Change)

As described above, the operation control unit 113 executes control to change the threshold relating to the operation amount of the operation member, such as the user's finger, for recognizing an operation as a user operation based on a change in the orientation of the housing 101 of the imaging apparatus 100 detected by the orientation change detection unit 112.

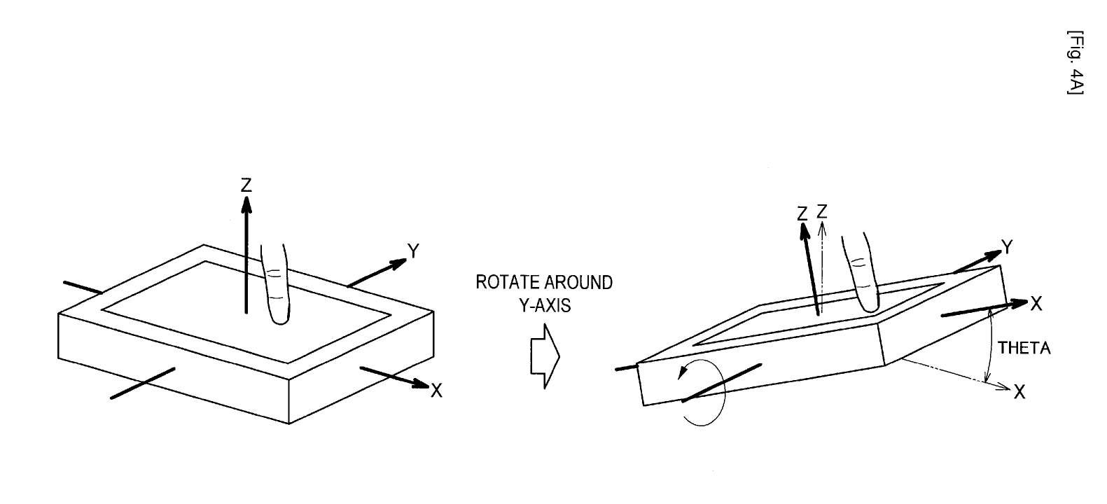

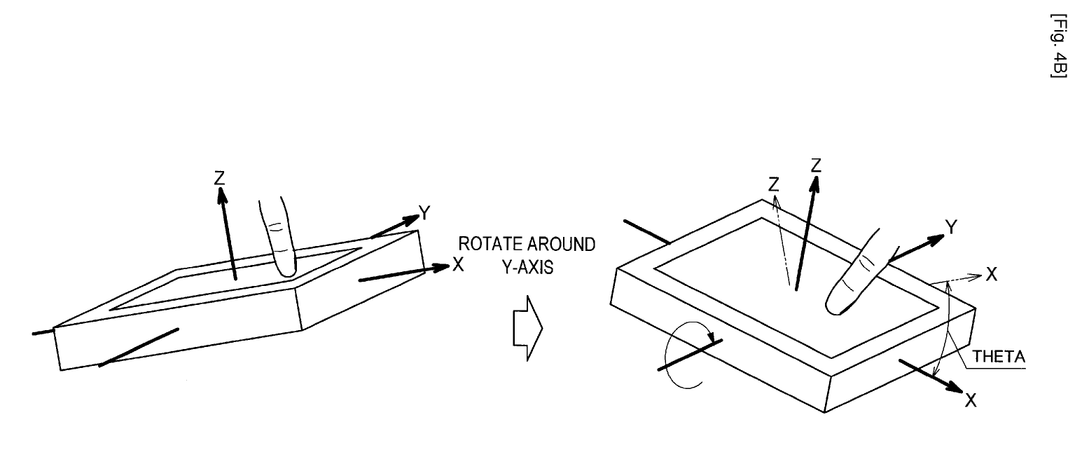

FIGS. 4A and 4B are explanatory diagrams illustrating an orientation change example of the housing 101 of the imaging apparatus 100. In FIGS. 4A and 4B, to facilitate the description, only the display unit 120 provided in the housing 101 is illustrated. FIGS. 4A and 4B illustrate a state in which the display unit 120 has been rotated by an angle theta around the Y-axis. The orientation change detection unit 112 detects such a change in the orientation of the housing 101 of the imaging apparatus 100. Then, the operation control unit 113 executes control to change the threshold relating to the operation amount of the operation member, such as the user's finger, for recognizing an operation as a user operation based on the change in the orientation of the housing 101 of the imaging apparatus 100.

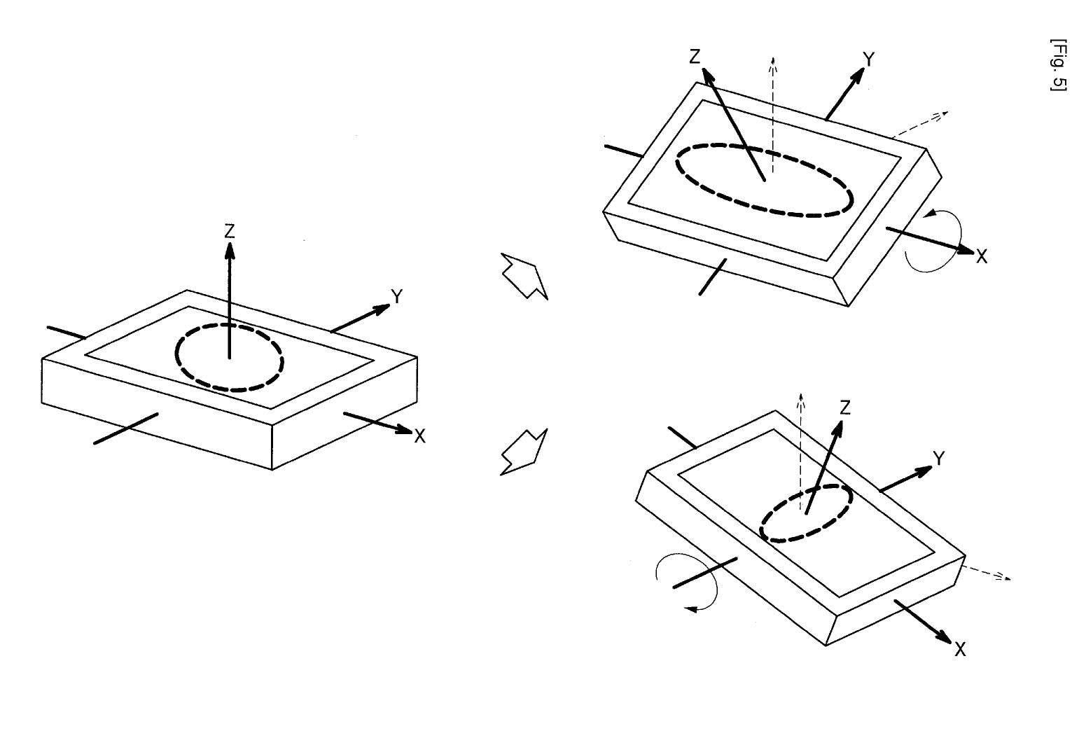

FIG. 5 is an explanatory diagram illustrating changes in the threshold relating to an operation amount of the operation member, such as the user's finger, for recognizing an operation as a user operation based on a change in the orientation of the housing 101 of the imaging apparatus 100. Similar to FIGS. 4A and 4B, to facilitate the description, only the display unit 120 provided in the housing 101 is illustrated in FIG. 5. Further, to facilitate the description, in FIG. 5 a distribution of the threshold relating to the operation amount of the operation member is illustrated on the display unit 120 as a circle.

During a normal period, namely, during a period in which a change in the orientation of the housing 101 of the imaging apparatus 100 has not been detected by the orientation change detection unit 112, the operation control unit 113 sets the distribution of the threshold relating to the operation amount of the operation member to a true circle. However, when a change in the orientation of the housing 101 of the imaging apparatus 100 is detected by the orientation change detection unit 112, the operation control unit 113 changes the distribution of the threshold relating to the operation amount of the operation member from a true circle to an ellipse based on the change in the orientation of the housing 101. When changing the threshold distribution to an ellipse, the operation control unit 113 changes the threshold distribution so that the direction in the rotation axis on the display unit 120 is changed to the long axis, and the direction orthogonal to the rotation axis on the display unit 120 is changed to the short axis. When there is a change in orientation, the operation control unit 113 can operate and determine based on a movement amount of the operation member that is less than during normal periods. It is noted that the change in the threshold distribution is not limited to this example. For example, the operation control unit 113 can change the threshold distribution in only the direction facing the ground.

An outline of changes to the threshold relating to the operation amount of the operation member performed by the imaging apparatus 100 according to an embodiment of the present disclosure was described above. In the description up to this point, the orientation change detection unit 112 detected changes in orientation of the housing 101 of the imaging apparatus 100, and the operation control unit 113 changed the threshold relating to the operation amount of the operation member based on the change in orientation of the housing 101 of the imaging apparatus 100. While the orientation change detection unit 112 is detecting changes in orientation of the housing 101 of the imaging apparatus 100, the orientation change detection unit 112 can also detect that the orientation has changed from a predetermined reference orientation. In the following, a case will be described in which the orientation change detection unit 112 detects changes in orientation from a predetermined reference orientation, and the operation control unit 113 changes the threshold relating to the operation amount of the operation member based on the change in orientation from a reference orientation of the housing 101 of the imaging apparatus 100.

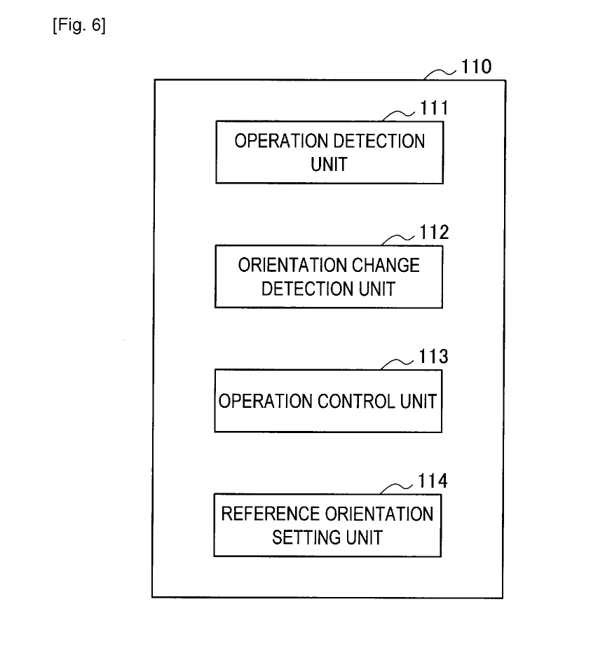

FIG. 6 is an explanatory diagram illustrating a function configuration example of the control unit 110 included in the imaging apparatus 100 according to an embodiment of the present disclosure. A function configuration example of the control unit 110 included in the imaging apparatus 100 according to an embodiment of the present disclosure will now be described with reference to FIG. 6.

As illustrated in FIG. 6, the control unit 110 included in the imaging apparatus 100 according to an embodiment of the present disclosure includes the operation detection unit 111, the orientation change detection unit 112, the operation control unit 113, and a reference orientation setting unit 114. Namely, the control unit 110 illustrated in FIG. 6 adds the reference orientation setting unit 114 to the control unit 110 illustrated in FIG. 3.

The reference orientation setting unit 114 sets a reference orientation of the housing 101 of the imaging apparatus 100 in order for the orientation change detection unit 112 to detect changes in orientation of the housing 101 of the imaging apparatus 100 from a predetermined reference orientation. The reference orientation setting unit 114 can employ various methods to set the reference orientation of the housing 101 of the imaging apparatus 100. For example, the reference orientation setting unit 114 may set the orientation of the housing 101 of the imaging apparatus 100 at the point when the operation detection unit 111 detected that the operation member touched or approached the touch panel 122 as the reference orientation. Further, for example, the reference orientation setting unit 114 may set the orientation of the housing 101 of the imaging apparatus 100 at the point when the operation detection unit 111 detected that an operation was made on the operation unit 130 as the reference orientation. In addition, for example, the reference orientation setting unit 114 may set the orientation of the housing 101 of the imaging apparatus 100 at the point when the operation detection unit 111 has not detected an operation on the operation unit 130 for a predetermined period as the reference orientation. Still further, for example, the reference orientation setting unit 114 may set the orientation of the housing 101 of the imaging apparatus 100 at the point when the operation detection unit 111 detected an operation other than a touch or an approach to the touch panel 122 as the reference orientation.

By setting the reference orientation of the housing 101 of the imaging apparatus 100 with the reference orientation setting unit 114, the orientation change detection unit 112 can detect whether the housing 101 of the imaging apparatus 100 has changed from the reference orientation based on information from the sensor unit 140.

For example, if an acceleration sensor is used for the sensor unit 140, the reference orientation setting unit 114 acquires a tilt angle of the housing 101 of the imaging apparatus 100 from the acceleration sensor, and stores that tilt angle in the RAM 160 as a reference. The orientation change detection unit 112 can detect whether the housing 101 of the imaging apparatus 100 has changed from the reference orientation by determining whether the housing 101 of the imaging apparatus 100 has changed from the reference angle based on information from the sensor unit 140. Further, for example, if an angular velocity sensor is used for the sensor unit 140, the reference orientation setting unit 114 initializes an integral value of an angular velocity acquired from the angular velocity sensor to zero. The orientation change detection unit 112 can detect whether the housing 101 of the imaging apparatus 100 has changed from the reference orientation by integrating angular velocities acquired from the rotation angular velocity sensor, and calculating the rotation angle of the housing 101 of the imaging apparatus 100.

A function configuration example of the control unit 110 included in the imaging apparatus 100 according to an embodiment of the present disclosure was described above with reference to FIG. 6. Next, an operation example of the imaging apparatus 100 according to an embodiment of the present disclosure will be described.

(Imaging Apparatus Operation Examples)

Operation examples of determining a drag operation by the user, a flick operation by the user, a long press operation by the user, and an approach to the touch panel by the user will now be described. It is noted that each of these operations is performed by the imaging apparatus 100 according to an embodiment of the present disclosure.

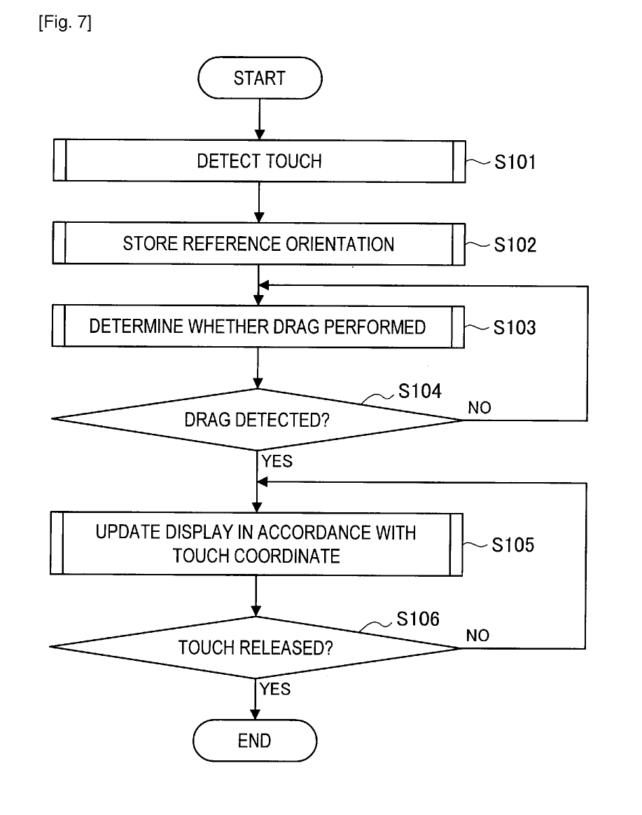

FIG. 7 is a flow diagram illustrating an operation example of the imaging apparatus 100 according to an embodiment of the present disclosure. The flow illustrated in FIG. 7 illustrates an operation example of when the imaging apparatus 100 according to an embodiment of the present disclosure determines a drag operation by the user. An operation example of the imaging apparatus 100 according to an embodiment of the present disclosure will now be described with reference to FIG. 7.

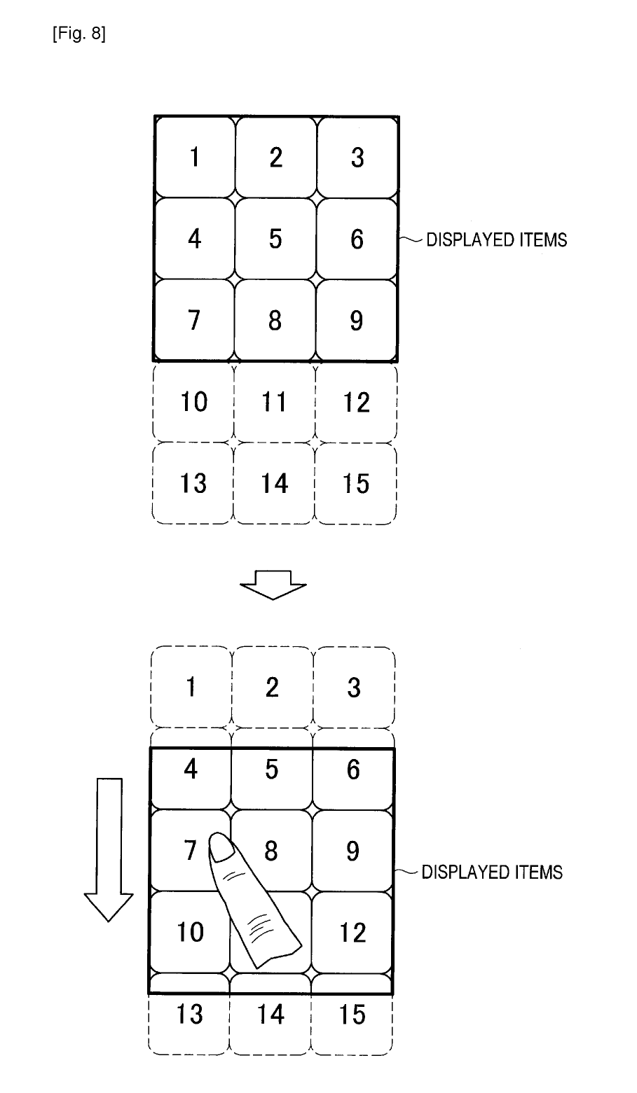

When the menu items for various menu displays do not fit within a single screen, normally some of the items are displayed, and the user can scroll through the items by performing a drag operation on the touch panel. Here, a drag operation is an operation in which, after a touch on the touch panel has been detected, the touch coordinate is moved while that touch is maintained. FIG. 8 is an explanatory diagram illustrating an example of a drag operation. FIG. 8 illustrates a case in which there are 15 menu items, but the number of menu items that can be displayed on one screen is 9. As illustrated in FIG. 8, when the user performs a drag operation, the menu display scrolls through the items while tracking the touch coordinate on the touch panel.

The imaging apparatus 100 detects a touch by the operation member, such as the user's finger, on the touch panel 122 with the operation detection unit 111 (step S101), and notifies the reference orientation setting unit 114 that there has been a touch by the operation member, such as the user's finger, on the touch panel 122. When the reference orientation setting unit 114 receives the notification from the operation detection unit 111 that there has been a touch by the operation member, such as the user's finger, on the touch panel 122, the orientation of the housing 101 of the imaging apparatus 100 at the time when there was the touch by the operation member, such as the user's finger, on the touch panel 122 is stored as a reference orientation of the housing 101 (step S102).

Next, the operation control unit 113 determines whether a drag operation was performed on the touch panel 122 based on the detection by the operation detection unit 111 of the touch by the operation member, such as the user's finger, on the touch panel 122 (step S103). Then, the operation control unit 113 determines whether a drag operation on the touch panel 122 was detected (step S104). Specifically, the operation control unit 113 calculates the difference between the initial touch coordinate of the operation member and the touch coordinate of the post-movement touch coordinate received from the touch panel 122, and if the difference is equal to or greater than a predetermined threshold, determines that a drag operation was performed. Here, the operation control unit 113 changes the threshold for the above-described drag determination based on how much the orientation of the housing 101 has changed from the housing 101 reference orientation that was stored in step S102. Table 1 shows an example of the drag determination threshold.

TABLE 1
Example of the drag determination threshold

| Touch coordi- | | | |
|---|---|---|---|
| nated Move- | Orientation change amount | | |
| ment amount | 0° ≦ \|theta\| < 30° | 30° ≦ \|theta\| < 60° | 60° ≦ \|theta\| |
| Less than 30 dots | Not a drag | Not a drag | Not a drag |
| 30 Dots or more | Not a drag | Not a drag | Drag |
| 40 Dots or more | Not a drag | Drag | Drag |
| 50 Dots or more | Drag | Drag | Drag |

As illustrated in Table 1, if the movement amount of the operation member is less than 30 dots, regardless of the how the orientation of the housing 101 changes, the operation control unit 113 determines that the operation is not a drag operation. Here, if the orientation of the housing 101 has been rotated by 60° or more from the reference orientation, and the movement amount of the touch coordinate of the operation member is 30 dots or more, the operation control unit 113 determines that a drag operation was performed. Further, if the orientation of the housing 101 has been rotated by 30° or more from the reference orientation, and the movement amount of the touch coordinate of the operation member is 40 dots or more, the operation control unit 113 determines that a drag operation was performed. In addition, if the orientation of the housing 101 has been rotated by 0° or more from the reference orientation, and the movement amount of the touch coordinate of the operation member is 50 dots or more, the operation control unit 113 determines that a drag operation was performed.

If it is determined in step S104 that a drag operation on the touch panel 122 was detected, the operation control unit 113 updates the display of the display unit 120 in accordance with the touch coordinate of the touch panel 122 of the operation member (step S105). On the other hand, if it is determined in step S104 that a drag operation on the touch panel 122 was not detected, the operation control unit 113 returns to the drag determination processing performed in step S103.

In step S105, after the operation control unit 113 has updated the display of the display unit 120 in accordance with the touch coordinate of the touch panel 122 of the operation member, the operation detection unit 111 determines whether a touch release of the operation member from the touch panel 122 has been detected (step S106). If it is determined in step S106 that the operation detection unit 111 has detected a touch release of the operation member from the touch panel 122, the processing is finished. On the other hand, if it is determined in step S106 that the operation detection unit 111 has not detected a touch release of the operation member from the touch panel 122, the update processing of the display of the display unit 120 in step S105 continues to be executed.

The imaging apparatus 100 according to an embodiment of the present disclosure can determine that a drag operation has been performed based on a small amount of movement by a finger when there has been a change in orientation by changing the threshold for determining that a drag operation has been performed based on the amount of change in orientation of the housing 101. By changing the threshold in this manner, the imaging apparatus 100 according to an embodiment of the present disclosure can shorten the distance that the user has to shift the operation member, such as a finger, so that the chances of a touch release being detected are reduced, thus making it easier to perform the drag operation.

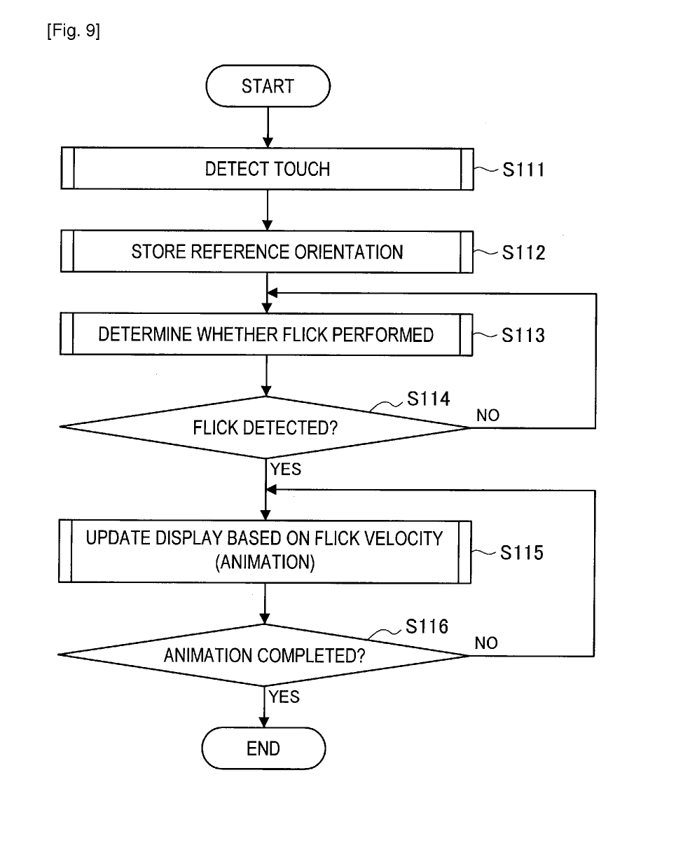

FIG. 9 is a flow diagram illustrating an operation example of the imaging apparatus 100 according to an embodiment of the present disclosure. The flow illustrated in FIG. 9 illustrates an operation example of when the imaging apparatus 100 according to an embodiment of the present disclosure determines a flick operation by the user. An operation example of the imaging apparatus 100 according to an embodiment of the present disclosure will now be described with reference to FIG. 9.

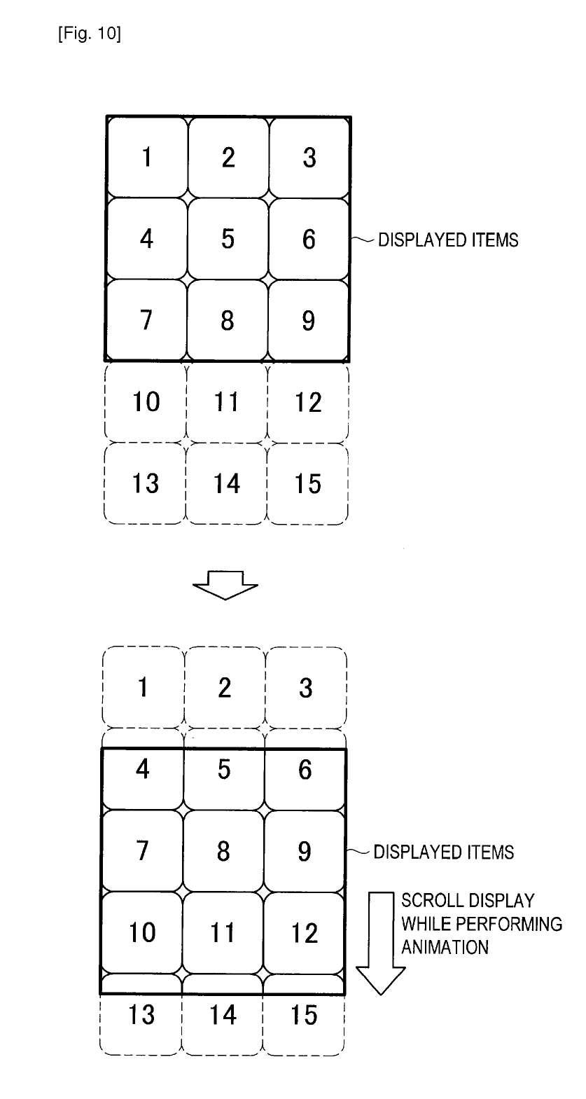

When the menu items for various menu displays do not fit within a single screen, normally some of the items are displayed, and the user can scroll through the items by performing a flick operation on the touch panel. Here, a flick operation is an operation in which, after a touch on the touch panel has been detected, the touch coordinate is moved while maintaining the touch, and the touch on the touch panel is then released. FIG. 10 is an explanatory diagram illustrating an example of a flick operation. FIG. 10 illustrates a case in which there are 15 menu items, but the number of menu items that can be displayed on one screen is 9. As illustrated in FIG. 10, when the user performs a flick operation on the menu screen, animation processing is performed in which the menu items are scrolled in accordance with the speed of change in the touch coordinate of the flick operation. Namely, the scroll amount of the menu items corresponds to the speed at which the user moves his/her finger. When the user scrolls through the display of the menu items by a flick operation, animation processing is performed for a certain period of time on the menu screen.

The imaging apparatus 100 detects a touch by the operation member, such as the user's finger, on the touch panel 122 with the operation detection unit 111 (step S111), and notifies the reference orientation setting unit 114 that there has been a touch by the operation member, such as the user's finger, on the touch panel 122. When the reference orientation setting unit 114 receives the notification from the operation detection unit 111 that there has been a touch by the operation member, such as the user's finger, on the touch panel 122, the orientation of the housing 101 of the imaging apparatus 100 at the time when there was the touch by the operation member, such as the user's finger, on the touch panel 122 is stored as a reference orientation of the housing 101 (step S112).

Next, the operation control unit 113 determines whether a flick operation was performed on the touch panel 122 based on the detection by the operation detection unit 111 of the touch by the operation member, such as the user's finger, on the touch panel 122 (step S113). Then, the operation control unit 113 determines whether a flick operation on the touch panel 122 was detected (step S114). Specifically, the operation control unit 113 calculates the difference between the initial touch coordinate of the operation member and the touch coordinate of the post-movement touch coordinate that were received from the touch panel 122, calculates the touch time from the touch start instant until the touch release instant, and if a flick velocity v is equal to or greater than a flick determination threshold, determines that a flick operation was performed. Here, the operation control unit 113 changes the threshold for the above-described flick determination based on how much the orientation of the housing 101 has changed from the housing 101 reference orientation that was stored in step S112. Table 2 shows an example of the flick determination threshold.

TABLE 2
Example of the flick determination threshold

| | Orientation change amount | | |
|---|---|---|---|
| Flick velocity | 0° ≦ \|theta\| < 30° | 30° ≦ \|theta\| < 60° | 60° ≦ \|theta\| |
| (v) < V0 | Not a flick | Not a flick | Not a flick |
| V0 < (v) < V1 | Not a flick | Not a flick | Flick |
| V1 ≦ (v) < V2 | Not a flick | Flick | Flick |
| V2 ≦ (v) | Flick | Flick | Flick |

As illustrated in Table 2, if the flick velocity v of the operation member is less than V0, regardless of the how the orientation of the housing 101 changes, the operation control unit 113 determines that the operation is not a flick operation. Here, if the orientation of the housing 101 has been rotated by 60° or more from the reference orientation, and the flick velocity v of the operation member is V0 or more to less than V1, the operation control unit 113 determines that a flick operation was performed. Further, if the orientation of the housing 101 has been rotated by 30° or more from the reference orientation, and the flick velocity v of the operation member is V1 or more to less than V2, the operation control unit 113 determines that a flick operation was performed. In addition, if the orientation of the housing 101 has been rotated by 0° or more from the reference orientation, and the flick velocity v of the operation member is V2 or more, the operation control unit 113 determines that a flick operation was performed.

If it is determined in step S114 that a flick operation on the touch panel 122 was detected, the operation control unit 113 updates the display of the display unit 120 in accordance with the touch coordinate of the touch panel 122 of the operation member (step S115). On the other hand, if it is determined in step S114 that a flick operation on the touch panel 122 was not detected, the operation control unit 113 returns to the flick determination processing performed in step S113.

In step S115, after the operation control unit 113 has updated the display of the display unit 120 in accordance with the touch coordinate of the touch panel 122 of the operation member, the operation detection unit 111 determines whether a touch release of the operation member from the touch panel 122 has been detected (step S116). If it is determined in step S116 that the operation detection unit 111 has detected a touch release of the operation member from the touch panel 122, the processing is finished. On the other hand, if it is determined in step S116 that the operation detection unit 111 has not detected a touch release of the operation member from the touch panel 122, the update processing of the display of the display unit 120 in step S115 continues to be executed.

The imaging apparatus 100 according to an embodiment of the present disclosure can determine that a flick operation has been performed based on a low movement velocity when there has been a change in orientation by changing the threshold for determining that a flick operation has been performed based on the amount of change in orientation of the housing 101. By changing the threshold in this manner, the imaging apparatus 100 according to an embodiment of the present disclosure can let the user move the operation member, such as a finger, more slowly, so that the chances of a touch release being detected are reduced, thus making it easier to perform the flick operation.

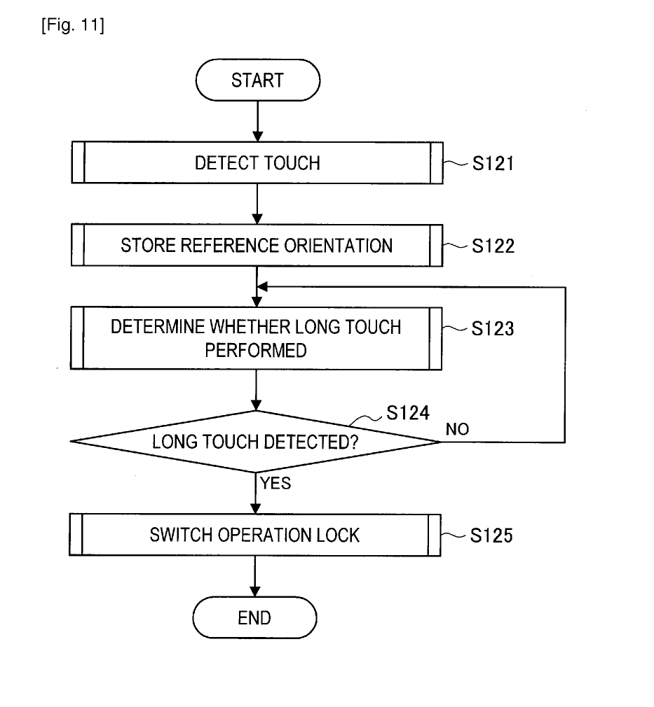

FIG. 11 is a flow diagram illustrating an operation example of the imaging apparatus 100 according to an embodiment of the present disclosure. The flow illustrated in FIG. 11 illustrates an operation example of when the imaging apparatus 100 according to an embodiment of the present disclosure determines a long press operation by the user. An operation example of the imaging apparatus 100 according to an embodiment of the present disclosure will now be described with reference to FIG. 11.

Many devices that have a touch panel also have a function for locking the touch operation. An example of such an operation is to provide a GUI button to switch between lock on and lock off, which switches between lock on and lock off when pressed for a long time. An operation example of the imaging apparatus 100 according to an embodiment of the present disclosure that is based on pressing a GUI button for a long time will be described below.

The imaging apparatus 100 detects a touch by the operation member, such as the user's finger, on the touch panel 122 with the operation detection unit 111 (step S121), and notifies the reference orientation setting unit 114 that there has been a touch by the operation member, such as the user's finger, on the touch panel 122. When the reference orientation setting unit 114 receives the notification from the operation detection unit 111 that there has been a touch by the operation member, such as the user's finger, on the touch panel 122, the orientation of the housing 101 of the imaging apparatus 100 at the time when there was the touch by the operation member, such as the user's finger, on the touch panel 122 is stored as a reference orientation of the housing 101 (step S122).

Next, the operation control unit 113 determines whether a long press operation was performed on the touch panel 122 based on the detection by the operation detection unit 111 of the touch by the operation member, such as the user's finger, on the touch panel 122 (step S123). Then, the operation control unit 113 determines whether a long press operation on the touch panel 122 was detected (step S124). Specifically, the operation control unit 113 calculates the touch time from the touch start instant until the touch release instant, and if a touch time t is equal to or greater than a long press determination threshold, determines that a long press operation was performed. Here, the operation control unit 113 changes the threshold for the above-described long press determination based on how much the orientation of the housing 101 has changed from the housing 101 reference orientation that was stored in step S122. Table 3 shows an example of the long press determination threshold.

TABLE 3
Example of the long press determination threshold

| | Orientation change amount | | |
|---|---|---|---|
| Touch time | 0° ≦ \|theta\| < 30° | 30° ≦ \|theta\| < 60° | 60° ≦ \|theta\| |
| (t) < T0 | Not a long touch | Not a long touch | Not a long touch |
| T0 < (t) < | Not a long touch | Not a long touch | Long touch |
| T1 | | | |
| T1 ≦ (t) < | Not a long touch | Long touch | Long touch |
| T2 | | | |
| T2 ≦ (t) | Long touch | Long touch | Long touch |

As illustrated in Table 3, if the touch time t of the operation member is less than T0, regardless of the how the orientation of the housing 101 changes, the operation control unit 113 determines that the operation is not a long press operation. Here, if the orientation of the housing 101 has been rotated by 60° or more from the reference orientation, and the touch time t of the operation member is T0 or more to less than T1, the operation control unit 113 determines that a long press operation was performed. Further, if the orientation of the housing 101 has been rotated by 30° or more from the reference orientation, and the touch time t of the operation member is T1 or more to less than T2, the operation control unit 113 determines that a long press operation was performed. In addition, if the orientation of the housing 101 has been rotated by 0° or more from the reference orientation, and the touch time t of the operation member is T2 or more, the operation control unit 113 determines that a long press operation was performed.

If it is determined in step S124 that a long press operation on the touch panel 122 was detected, the operation control unit 113 executes processing to switch the operation lock (step S125). On the other hand, if it is determined in step S124 that a long press on the touch panel 122 was not detected, the operation control unit 113 returns to the long press determination processing performed in step S123.

The imaging apparatus 100 according to an embodiment of the present disclosure can determine that a long press operation has been performed based on a short touch time when there has been a change in orientation by changing the threshold for determining that a long press operation has been performed based on the amount of change in orientation of the housing 101. By changing the threshold in this manner, the imaging apparatus 100 according to an embodiment of the present disclosure can be expected to improve operability since there is a lower possibility of a touch release being detected.

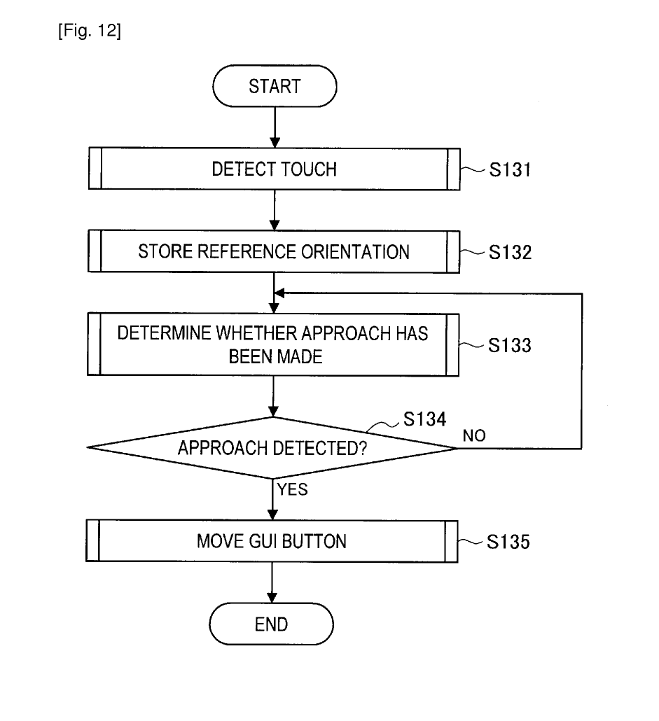

FIG. 12 is a flow diagram illustrating an operation example of the imaging apparatus 100 according to an embodiment of the present disclosure. The flow illustrated in FIG. 12 illustrates an operation example of when the imaging apparatus 100 according to an embodiment of the present disclosure determines an approach toward the touch panel by the user. An operation example of the imaging apparatus 100 according to an embodiment of the present disclosure will now be described with reference to FIG. 12.

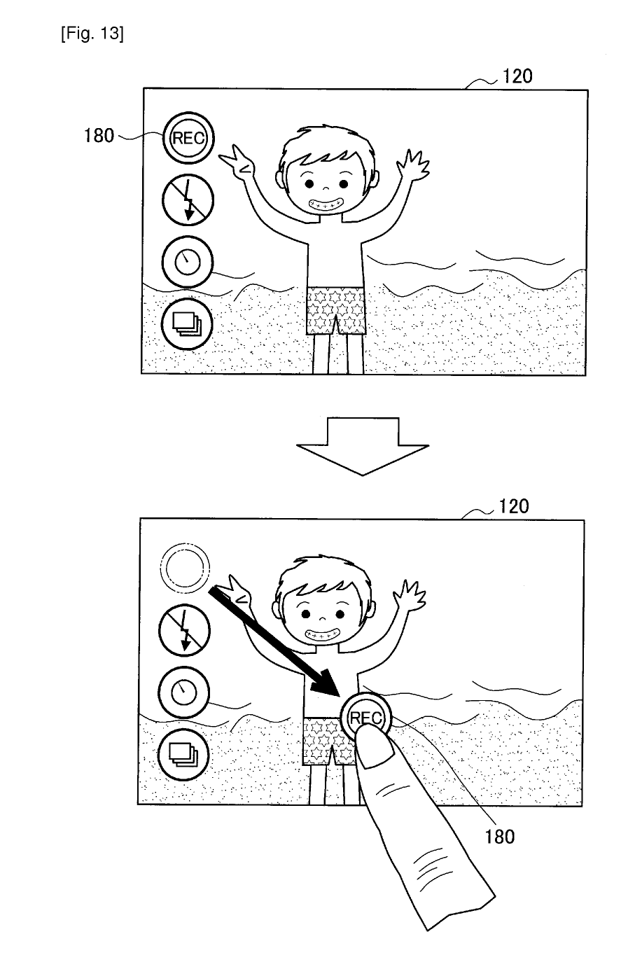

Recently, capacitive touch panels that can detect not only the touch of a finger, but also the approach of a finger are widely known. An approach can be detected by monitoring changes in the electrostatic capacitance. Further, also known are touch panels capable detecting the distance between the touch panel and a finger by arranging a plurality of sensors in a capacitive touch panel to improve the electrostatic capacitance resolution performance. FIG. 13 is an explanatory diagram illustrating an example of a GUI that changes a display position of an icon based on approach detection.

The imaging apparatus 100 detects an approach by the operation member, such as the user's finger, on the touch panel 122 with the operation detection unit 111 (step S131), and notifies the reference orientation setting unit 114 that there has been an approach by the operation member, such as the user's finger, toward the touch panel 122. When the reference orientation setting unit 114 receives the notification from the operation detection unit 111 that there has been an approach by the operation member, such as the user's finger, toward the touch panel 122, the orientation of the housing 101 of the imaging apparatus 100 at the time when there was the approach by the operation member, such as the user's finger, toward the touch panel 122 is stored as a reference orientation of the housing 101 (step S132).

Next, the operation control unit 113 determines whether an approach has been made toward the touch panel 122 based on the detection by the operation detection unit 111 of an approach by the operation member, such as the user's finger, toward the touch panel 122 (step S133). Then, the operation control unit 113 determines whether an approach toward the touch panel 122 was detected (step S134). Specifically, the operation control unit 113 calculates a distance d from the user's finger to the touch panel 122, and if the distance d is less than an approach threshold, determines that an approach has been made. Here, the operation control unit 113 changes the threshold for the above-described approach determination based on how much the orientation of the housing 101 has changed from the housing 101 reference orientation that was stored in step S132. Table 4 shows an example of the approach determination threshold.

TABLE 4
Example of the approach determination threshold

| Approach | Orientation change amount | | |
|---|---|---|---|
| distance | 0° ≦ \|theta\| < 30° | 30° ≦ \|theta\| < 60° | 60° ≦ \|theta\| |
| (d) < D0 | Approach | Approach | Approach |
| D0 < (d) < D1 | Approach | Approach | No approach |
| D1 ≦ (d) < D2 | Approach | No approach | No approach |
| D2 ≦ (d) | No approach | No approach | No approach |

As illustrated in Table 4, if the distance d is less than D0, regardless of the how the orientation of the housing 101 changes, the operation control unit 113 determines that an approach has been made. Here, if the orientation of the housing 101 has been rotated by 60° or more from the reference orientation, and the distance d is D0 or more to less than D1, the operation control unit 113 determines that an approach has not been made. Further, if the orientation of the housing 101 has been rotated by 30° or more from the reference orientation, and the distance d is D1 or more to less than D2, the operation control unit 113 determines that an approach has not been made. In addition, if the orientation of the housing 101 has been rotated by 0° or more from the reference orientation, and the distance d is D2 or more, the operation control unit 113 determines that an approach has not been made.

If it is determined in step S134 that the approach of the user's finger has been detected, the operation control unit 113 executes movement processing of the GUI button (step S135). On the other hand, if it is determined in step S134 that the approach of the user's finger has not been detected, the operation control unit 113 returns to the approach determination processing performed in step S133.

The imaging apparatus 100 according to an embodiment of the present disclosure can determine the presence of an approach based on a short distance when there has been a change in orientation by changing the threshold for determining an approach based on the amount of change in orientation of the housing 101. By changing the threshold in this manner, the imaging apparatus 100 according to an embodiment of the present disclosure can be expected to prevent mistaken operation and improve operability.

Operation examples of the imaging apparatus 100 according to an embodiment of the present disclosure were described above with reference to the drawings. Obviously, the user operations controlled by the imaging apparatus 100 according to an embodiment of the present disclosure are not limited to these examples. For instance, the imaging apparatus 100 according to an embodiment of the present disclosure may also change the threshold for a pinch operation (drawing the fingers closer and then moving them further away) performed using two fingers based on the change in orientation of the housing 101.

Next, an example of the imaging apparatus 100 according to an embodiment of the present disclosure releasing the reference orientation temporarily set by the reference orientation setting unit 114 will be described. When a reference orientation has been set by the reference orientation setting unit 114, the imaging apparatus 100 according to an embodiment of the present disclosure can make the reference orientation setting unit 114 release the reference orientation setting if an operation is not detected by the operation detection unit 111 for a predetermined duration. Further, when a reference orientation has been set by the reference orientation setting unit 114, the imaging apparatus 100 according to an embodiment of the present disclosure can also make the reference orientation setting unit 114 release the reference orientation setting if the fact that the user touched a specific GUI button on the display unit 120 is detected by the operation detection unit 111.

In addition, when a reference orientation has been set by the reference orientation setting unit 114, the imaging apparatus 100 according to an embodiment of the present disclosure can also make the reference orientation setting unit 114 release the reference orientation setting if the fact that the user touched a certain specific button on the operation unit 130 is detected by the operation detection unit 111. Still further, when a reference orientation has been set by the reference orientation setting unit 114, the imaging apparatus 100 according to an embodiment of the present disclosure can also make the reference orientation setting unit 114 release the reference orientation setting if the fact that the user has made a specific gesture toward the touch panel 122 is detected by the operation detection unit 111.

Accordingly, the imaging apparatus 100 according to an embodiment of the present disclosure can release the reference orientation temporarily set by the reference orientation setting unit 114 based on what the user operation is. By releasing the reference orientation temporarily set by the reference orientation setting unit 114 based on what the user operation is, the imaging apparatus 100 according to an embodiment of the present disclosure can avoid a deterioration in operability resulting from the unintended setting by the user of a reference orientation.

### 2. CONCLUSION

Thus, the imaging apparatus 100 according to an embodiment of the present disclosure changes a threshold relating to an operation amount of an operation member, such as a user's finger, for recognizing an operation as a user operation based on a change in the orientation of the housing 101. By thus changing the threshold relating to the operation amount of the operation member, the imaging apparatus 100 according to an embodiment of the present disclosure can improve operability when the user performs an operation on the touch panel.

Since the imaging apparatus 100 according to an embodiment of the present disclosure changes the threshold based on the direction of the change in orientation of the housing 101, the operator of the imaging apparatus 100 can convey to the imaging apparatus 100 an operation direction, such as a drag operation or a flick operation, based on the direction of the change in orientation. Consequently, the operator of the imaging apparatus 100 can perform a drag operation or a flick operation in the direction that he/she wants more easily by changing the orientation of the housing 101.

Further, in the embodiment of the present disclosure described above, although the imaging apparatus 100 was described as an example of the information processing apparatus according to an embodiment of the present disclosure, needless to say the information processing apparatus according to an embodiment of the present disclosure is not limited to an imaging apparatus. For example, the present technology can also be applied to a personal computer, a tablet terminal, a mobile telephone, a smartphone, a portable music player, a portable television receiver and the like.

In addition, in the embodiment of the present disclosure described above, although the operation amount threshold for recognizing the approach or touch of a user's finger on the touch panel 122 of the imaging apparatus 100 as a user operation was changed, the present disclosure is not limited to such an example. For example, the operation amount threshold for recognizing the approach or touch of an operation member such as a stylus as a user operation can be changed.

The respective steps in the processing executed by the various apparatuses described in the present disclosure do not have to be performed in chronological order according to the order described as a sequence diagram or flowchart. For example, the respective steps in the processing executed by the various apparatuses can be carried out in a different order to that described in the flowcharts, or can be carried out in parallel.

In addition, a computer program can be created that makes hardware, such as a CPU, ROM, and RAM, in the various apparatuses realize functions equivalent to the parts of the various above-described apparatuses. Still further, a storage medium on which such a computer program is stored can also be provided. Moreover, series of processes can also be realized by hardware by configuring the respective function blocks illustrated in the function block diagrams as hardware.

It should be understood by those skilled in the art that various modifications, combinations, sub-combinations and alterations may occur depending on design requirements and other factors insofar as they are within the scope of the appended claims or the equivalents thereof.

The present disclosure may be configured as below.
(1) An information processing system including: circuitry configured to identify a change in posture of the information processing system; and determine whether a user input is received at the operation surface based on the identified change in posture of the information processing system.
(2) The information processing system of (1), wherein the circuitry is configured to: identify a change in posture of the information processing system based on the identified posture; and determine whether the user input is received at the operation surface based on the identified change in posture of the information processing system.
(3) The information processing system of (2), wherein the circuitry is configured to determine the user input as a touch or approach by an operation member to the operation surface.
(4) The information processing system of any of (2) to (3), wherein the circuitry is configured increase a sensitivity for determining whether a user input is received at the operation surface as the identified change in posture of the information processing system increases.
(5) The information processing system of any of (2) to (4), wherein the circuitry is configured to modify a threshold for determining whether a user input is received operation surface based on the identified change in posture of the information processing system.
(6) The information processing system of (5), wherein the circuitry is configured to decrease the threshold for determining whether a user input is received at the operation surface as the identified change in posture of the information processing system increases.
(7) The information processing system of any of (2) to (6), wherein the circuitry is configured to change a threshold distance for determining a user input as a drag input received at the operation surface based on the identified change in posture of the information processing system.
(8) The information processing system of (7), wherein the circuitry is configured to decrease the threshold distance for determining the user input as the drag input received at the operation surface as the identified change in posture of the information processing system increases.
(9) The information processing system of any of (1) to (8), wherein the circuitry is configured to change a threshold velocity for determining a user input received at the operation surface as a flick input based on the identified change in posture of the information processing system.
(10) The information processing system of (9), wherein the circuitry is configured to decrease the threshold velocity for determining the user input received at the operation surface as the flick input as the identified change in posture of the information processing system increases.
(11) The information processing system of any of (2) to (10), wherein the circuitry is configured to change a threshold time for determining the user input received at the operation surface as a long press input based on the identified change in posture of the information processing system.
(12) The information processing system of (11), wherein the circuitry is configured to decrease the threshold time for determining the user input received at the operation surface as the long press input as the detected change in posture of the information processing system increases.
(13) The information processing system of any of (2) to (12), wherein the circuitry is configured to change a threshold distance between an operation object approaching the operation surface and the operation surface for determining user input received at the operation surface as an approach input based on the identified change in posture of the information processing system.
(14) The information processing system of (13), wherein the circuitry is configured to decrease the threshold distance for determining the user input received at the operation surface as the approach input as the detected change in posture of the information processing system increases.
(15) The information processing system of any of (2) to (14), further including: a sensor unit configured to detect a rotation angle of the information processing system around at least one of a first axis, a second axis and a third axis.
(16) The information processing system of (15), wherein the circuitry is configured to identify the change in posture of the information processing system based on an output of the sensor unit.
(17) The information processing system of any of (2) to (17), wherein the circuitry is configured to set, as a reference posture, a posture of the information processing system when a user input to the operation surface is first detected.
(18) The information processing system of (17), wherein the circuitry is configured to identify the change in posture of the information processing system as a difference between a currently detected posture of the information processing system and the reference posture.
(19) The information processing system of any of (2) to (18), wherein the circuitry is configured to set, as a reference posture, a posture of the information processing system when a user input to the operation surface has not been detected for more than a predetermined period of time.
(20) The information processing system of (19), wherein the circuitry is configured to identify the change in posture of the information processing system as a difference between a currently detected posture of the information processing system and the reference posture.
(21) The information processing system of any of (1) to (20), further including: the operation surface.
(22) The information processing system of (21), further including: an image capturing unit configured to capture images of a subject; and the display is configured to display the images captured by the image capturing unit.
(23) A method performed by an information processing system, the method including: identifying, by circuitry of the information processing system, a posture of the information processing system; and determining, by the circuitry, whether a user input is received at the operation surface based on the identified posture of the information processing system.
(24) A non-transitory computer-readable medium including computer-program instructions, which when executed by an information processing system, cause the information processing system to: identify a posture of the information processing system; and determine whether a user input is received at an operation surface based on the identified posture of the information processing system.
(25) An information processing apparatus including:
an operation detection unit configured to detect a user operation that includes a touch or an approach by an operation member;
an orientation change detection unit configured to detect a change in an orientation of a housing; and
an operation control unit configured to change a threshold relating to an operation amount of the operation member for recognizing the touch or the approach detected by the operation detection unit as a user operation based on the change in the orientation of the housing detected by the orientation change detection unit.
(26) The information processing apparatus according to (25), further including: a reference orientation setting unit configured to set a reference orientation of the housing,
wherein the operation control unit is configured to change the threshold when the orientation change detection unit detects that the orientation of the housing has changed from the reference orientation of the housing set by the reference orientation setting unit.
(27) The information processing apparatus according to (26), wherein the reference orientation setting unit is configured to set, as the reference orientation, the orientation of the housing at a point when the operation detection unit has detected the touch or the approach by the operation member.
(28) The information processing apparatus according to (26), wherein, in a case where the orientation of the housing is less than a predetermined duration and a predetermined change amount, the reference orientation setting unit is configured to set, as the reference orientation, the orientation of the housing when the predetermined duration has elapsed.
(29) The information processing apparatus according to (26), wherein, in a case where a user operation has not been detected by the operation detection unit for a predetermined duration, the reference orientation setting unit is configured to set, as the reference orientation, the orientation of the housing when the predetermined duration has elapsed.
(30) The information processing apparatus according to (26), wherein the reference orientation setting unit is configured to set, as the reference orientation, the orientation of the housing at a point when a user operation other than a touch or an approach by the operation member has been detected.
(31) The information processing apparatus according to any one of (25) to (30), wherein the operation control unit is configured to change a distribution of the threshold based on a tilt axis of the housing.
(32) The information processing apparatus according to any one of (25) to (31), wherein the operation control unit is configured to change a distribution of the threshold to an elliptical shape.
(33) The information processing apparatus according to (32), wherein the operation control unit is configured to change the distribution of the threshold to the elliptical shape in a manner that a long axis coincides with a tilt axis of the housing.
(34) The information processing apparatus according to (25), wherein the operation control unit is configured to change a distribution of the threshold in only a direction that faces a ground.
(35) The information processing apparatus according to any one of (25) to (34), wherein the operation control unit is configured to change a threshold for recognizing a drag operation by the operation member.
(36) The information processing apparatus according to any one of (25) to (35), wherein the operation control unit is configured to change a threshold for recognizing a flick operation by the operation member.
(37) The information processing apparatus according to any one of (25) to (36), wherein the operation control unit is configured to change a threshold for recognizing a long press operation by the operation member.
(38) The information processing apparatus according to any one of (25) to (37), wherein the operation control unit is configured to change a threshold for recognizing an approach by the operation member.
(39) The information processing apparatus according to any one of (25) to (38), wherein the operation control unit is configured to change a threshold for recognizing a pinch operation by the operation member.
(40) An information processing method including:
detecting a user operation that includes a touch or an approach by an operation member;
detecting a change in an orientation of a housing; and
changing a threshold relating to an operation amount of the operation member for recognizing the touch or the approach detected in the operation detection step as a user operation based on the change in the orientation of the housing detected in the orientation change detection step.
(41) A computer program for causing a computer to execute:
detecting a user operation that includes a touch or an approach by an operation member;
detecting a change in an orientation of a housing; and
changing a threshold relating to an operation amount of the operation member for recognizing the touch or the approach detected in the operation detection step as a user operation based on the change in the orientation of the housing detected in the orientation change detection step.

### REFERENCE SIGNS LIST

100 Imaging apparatus
101 Housing
110 Control unit
111 Operation detection unit
112 Orientation change detection unit
113 Operation control unit
120 Display unit
130 Operation unit
140 Sensor unit
150 Flash memory
160 RAM

1. An information processing system comprising:
circuitry configured to
identify a posture of the information processing system; and
determine whether a user input is received at the operation surface based on the identified posture of the information processing system.

2. The information processing system of claim 1, wherein the circuitry is configured to:
identify a change in posture of the information processing system based on the identified posture; and
determine whether the user input is received at the operation surface based on the identified change in posture of the information processing system.

3. The information processing system of claim 2, wherein
the circuitry is configured to determine the user input as a touch or approach by an operation member to the operation surface.

4. The information processing system of claim 2, wherein
the circuitry is configured increase a sensitivity for determining whether a user input is received at the operation surface as the identified change in posture of the information processing system increases.

5. The information processing system of claim 2, wherein
the circuitry is configured to modify a threshold for determining whether a user input is received operation surface based on the identified change in posture of the information processing system.

6. The information processing system of claim 5, wherein
the circuitry is configured to decrease the threshold for determining whether a user input is received at the operation surface as the identified change in posture of the information processing system increases.

7. The information processing system of claim 6, wherein
the threshold is associated with a distance for determining a user input as a drag input received at the operation surface based on the identified change in posture of the information processing system.

8. The information processing system of claim 6, wherein
the threshold is associated with a velocity for determining a user input received at the operation surface as a flick input based on the identified change in posture of the information processing system.

9. The information processing system of claim 6, wherein
the threshold is associated with a time for determining the user input received at the operation surface as a long press input based on the identified change in posture of the information processing system.

10. The information processing system of claim 6, wherein
the threshold is associated with a distance between an operation object approaching the operation surface and the operation surface for determining user input received at the operation surface as an approach input based on the identified change in posture of the information processing system.

11. The information processing system of claim 2, further comprising:
a sensor unit configured to detect a rotation angle of the information processing system around at least one of a first axis, a second axis and a third axis.

12. The information processing system of claim 11, wherein
the circuitry is configured to identify the change in posture of the information processing system based on an output of the sensor unit.

13. The information processing system of claim 2, wherein
the circuitry is configured to set, as a reference posture, a posture of the information processing system when a user input to the operation surface is first detected.

14. The information processing system of claim 13, wherein
the circuitry is configured to identify the change in posture of the information processing system as a difference between a currently detected posture of the information processing system and the reference posture.

15. The information processing system of claim 2, wherein
the circuitry is configured to set, as a reference posture, a posture of the information processing system when a user input to the operation surface has not been detected for more than a predetermined period of time.

16. The information processing system of claim 15, wherein
the circuitry is configured to identify the change in posture of the information processing system as a difference between a currently detected posture of the information processing system and the reference posture.

17. The information processing system of claim 1, further comprising:
the operation surface.

18. The information processing system of claim 17, further comprising:
an image capturing unit configured to capture images of a subject; and
a display configured to display the images captured by the image capturing unit.

19. A method performed by an information processing system, the method comprising:
identifying, by circuitry of the information processing system, a posture of the information processing system; and
determining, by the circuitry, whether a user input is received at the operation surface based on the identified posture of the information processing system.

20. A non-transitory computer-readable medium including computer-program instructions, which when executed by an information processing system, cause the information processing system to:
identify a posture of the information processing system; and
determine whether a user input is received at an operation surface based on the identified posture of the information processing system.
